(19) United States
(12) Patent Application Publication
(10) Pub. No.: US 2015/0329384 A1
(43) Pub. Date: Nov. 19, 2015

(54) RECHARGEABLE ELECTROCHEMICAL CELLS

(71) Applicant: 3M INNOVATIVE PROPERTIES COMPANY, St. Paul, MN (US)

(72) Inventor: Robert E. Astle, Middlefield, CT (US)

(21) Appl. No.: 14/655,220

(22) PCT Filed: Jan. 30, 2014
(86) PCT No.: PCT/US2014/013759

§ 371 Date: Jun. 24, 2015

Related U.S. Application Data
(60) Provisional application No. 61/759,905, filed on Feb. 1, 2013.

(51) Int. Cl. C02F 1/461; C25B 9/10

(52) U.S. Cl. CPC C02F 1/4618; C25B 9/10; C02F 2201/46115; C02F 2201/4618

(57) ABSTRACT

Provided are electrochemical devices that are rechargeable, where an electrolyte stream whose electrolyte is electro-chemically inert is supplied to an ion concentrate compartment between a bipolar membrane and an electrode, thereby eliminating a potential for scale build-up. When strong or weak cation resins are used in a product compartment of an electrochemical device, acid water produced can be used to soak and clean an ion concentrate compartment next to an electrode, such as the cathode.

### FIELD

The present invention relates to the field of electrochemical cells for supplying purified and/or acid water and/or basic water and processes for using the same, and, more particularly, to the field of electrochemical cells that are rechargeable where fouling and scaling are minimized during regeneration.

### BACKGROUND

Salts dissolved in freshwater sources, measured as water hardness or total dissolved solids (TDS), can create problems in industrial, commercial, and residential uses of water, and processes to remove these salts have long been practiced. As human freshwater use intensifies, our water sources are becoming increasingly saline due to a variety of causes: agricultural runoff; urban runoff containing road salt; over-pumping of groundwater leading to intrusion of seawater into aquifers; and exploitation of brackish water sources not previously considered for human use. Thus, the demand for TDS reduction is expected to increase into the future, and new technologies will be required to improve the efficiency and environmental sustainability of TDS reduction processes.

The level of TDS in U.S. tap water generally ranges from 140 to 400 ppm. At concentrations of more than 25 ppm TDS example, certain disadvantages to consumer are notices. For example, the appearance of water spots remaining after the use of a residential dishwasher (using phosphate-free detergents) is strongly diminished at TDS concentrations of less than about 25 ppm. Certain known mixed bed resin commercial technologies are capable of producing this quality of water over a wide range of inlet water conditions with a simple, small footprint design and no waste stream, but in order to treat such resin loaded to capacity, strong acids and bases are needed, which is an operation not amenable to consumer or light commercial applications.

Electrochemical reactions provided by electrochemical cells (EC) are also known as one way to purify water. Exemplary electrochemical cells are disclosed in PCT/US2012/048922, which is incorporated herein by reference. Electrodeionization (EDI) cells (or devices or modules) use electrochemical reactions to specifically generate deionized water. EDI cells are typically used to create ultrapure water for electronics, pharmaceutical, power generation, and cooling tower applications. EDI modules include the following components: product and concentrate (or reject) compartments separated by an ion exchange membrane such as selectively cation permeable membranes (CPMs) and selectively anion permeable membranes (APMs) that are situated between an anode and a cathode. The product and concentrate compartments are each filled with a mixture of anion exchange and cation exchange resin beads. Feed water (which is usually water from a reverse osmosis (RO) device requiring ultrapurification) enters both the product and the concentrate compartments and a voltage is continuously applied across the anode and cathode. In the product compartments, cations bind to cation exchange resin beads, and then the cations migrate from site to site on the cation exchange resin beads, in the direction of the cathode until they cross a CPM into a concentrate compartment. Also in the product compartments, anions bind to anion exchange resin beads, and then the anions migrate in an opposite direction compared to the cations until they cross an APM into a concentrate compartment. In the concentrate compartments, both cations and anions are prevented from passing into product compartments by the selective membranes. In this way, the water in the product compartments can reach very low TDS applicable to ultrapure water applications. Further, the applied electric field results in hydrolysis of water at the interfaces between cation exchange and anion exchange resins, continuously regenerating them into the acid and base forms, respectively. Neither chemical additions nor high pressures are required in such operations.

When strong or weak cation resins are used in conjunction with a CPM and a bipolar membrane, acid water can be provided. Acid water from electrochemical cells can, in turn, supply waste streams of ion reduction devices for flushing ions and reducing scale in ion concentration compartments as discussed in co-assigned U.S. Prov. Ser. No. 61/758,467, incorporated herein by reference. Ion reduction devices include but are not limited to deionization systems, continuous or batch-wise, and reverse-osmosis systems. When strong or weak basic or anionic resins are used in conjunction with an APM and a bipolar membrane, basic water can be provided.

Recharging electrochemical cells themselves requires sending a waste stream through electrochemical cell concentrate compartments, where the waste stream accumulates the ions or solids being removed, which can then result in fouling of ion exchange membranes. There is an ongoing need to avoid fouling in rechargeable electrochemical cells.

### SUMMARY

Provided are electrochemical devices that are rechargeable, where the regeneration techniques include using an electrolyte stream whose electrolyte is electrochemically inert in an anolyte or catholyte compartment and/or using an acid water in a catholyte compartment.

A first aspect provides an electrochemical cell comprising: a product compartment containing one or more ion-exchange resins; a catholyte compartment and an anolyte compartment; a bipolar membrane; an ion-exchange membrane selected from the group consisting of a cation-permeable membrane and an anion-permeable membrane; and a cathode and an anode; and one or both of the following structures: a closed loop of an electrolyte stream in fluid communication with the bipolar membrane and either the anolyte compartment or the catholyte compartment and a slip stream that puts the ion-exchange membrane in fluid communication with the product compartment.

In one or more embodiments and in conjunction with any of the following variations, the electrochemical cell comprises the closed loop of the electrolyte stream. The electrolyte can comprise one or more ions that are electrochemically inert upon application of current to the cell. The electrolyte can comprise an ion with a high half cell potential. In detailed embodiments, the electrolyte comprises sodium sulfate, sodium fluoride, potassium sulfate, potassium fluoride, or combinations thereof.

In one or more embodiments, the electrochemical cell comprises the slip stream.

In one embodiment, the one or more ion-exchange resins comprises a cation exchange resin and the ion-exchange membrane comprises the cation-permeable membrane. In another embodiment, the one or more ion-exchange resins comprises an anion exchange resin and the ion-exchange membrane comprises the anion-permeable membrane.

When the one or more ion-exchange resins comprises a strong acid cation resin and the ion-exchange membrane comprises the cation-permeable membrane, the slip stream can deliver acid water from the product compartment to the catholyte compartment.

The electrochemical cell can comprise two or more product compartments being separated by one or more concentrate compartments and containing one or more ion-exchange resins, each product compartment bounded by a pair of an ion-exchange membrane and a bipolar membrane.

The electrochemical cell can be operated batch-wise. Batch-wise operations may find several useful consumer applications such as use with dishwashers and coffee and steamers to treat a finite amount of water after each cycle. Another possible application is metal scavengers. One or more embodiments provide that the electrochemical cell has a service mode where no current density is applied to the electrochemical cell and a recharge mode where a current density is applied to the electrochemical cell. In an embodiment, the current density is a low current density effective to substantially keep dissolved ions in solution in regions adjacent to the surfaces of the bipolar membrane and the at least one ion-exchange membrane during the recharge mode.

Other embodiments provide that the electrochemical cell comprises two or more product compartments that contain a strong cation resin, an additional cathode adjacent to an additional catholyte compartment, an additional anolyte compartment that is adjacent to the anode, and the closed loop of the electrolyte stream, wherein the closed loop of the electrolyte stream flows through one or both of the anolyte compartments.

Other aspects provide methods of treating water comprising: flowing water through the electrochemical cells provided herein. Methods can include operating the electrochemical cell batch-wise having a service mode where no current density is applied to the electrochemical cell and a recharge mode where a current density is applied to the electrochemical cell.

One embodiment provides that during the recharge mode, the electrolyte stream is supplied to one of the anolyte compartment and the catholyte compartment.

One embodiment provides that during the service mode, acid water from the product compartment flows through the slip stream and into the catholyte compartment.

A detailed aspect provides a multi-paired electrochemical cell comprising: two or more product compartments containing one or more ion-exchange resins; a catholyte compartment and an anolyte compartment; two or more pairs of a bipolar membrane and a cation-permeable membrane; a cathode and an anode; and a closed loop of an electrolyte stream in fluid communication with the bipolar membrane and the anolyte compartment, wherein the electrolyte comprises one or more ions that are electrochemically inert upon application of current to the electrochemical cell. The two product or more compartments may contain a strong cation resin or a weak cation resin and wherein the closed loop of the electrolyte stream flows through the anolyte compartment.

### BRIEF DESCRIPTION OF THE DRAWINGS

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a schematic drawing of an embodiment of an electrochemical cell showing flow of a waste stream comprising an electrolyte stream through the anolyte compartment in which the electrolyte is electrochemically inert during regeneration of the strong cation resin;

FIG. 2 is a schematic drawing of an embodiment of an electrochemical cell showing flow of a waste stream comprising an electrolyte stream through the catholyte compartment in which the electrolyte is electrochemically inert during regeneration of the strong cation resin;

FIG. 3 is a schematic drawing of an embodiment of an electrochemical cell showing direction of service flow of a product stream (for example, tap water) through a bed of cation resin where acid water is formed, a portion of which is routed to the catholyte compartment;

FIG. 4 is a schematic drawing of an embodiment having multiple product compartments in parallel;

FIG. 5 is a graph of pH versus throughput of the waste water stream during a recharge mode using a strong acid cation exchange cell with bipolar membrane (SAC Bipolar Cell);

FIG. 6 is a graph of conductivity versus throughput during a recharge mode with a SAC Bipolar Cell;

FIG. 7 is a photograph of the bipolar membrane of a SAC Bipolar Cell facing the anode showing no scale precipitation;

FIG. 8 is a photograph of the anode of a SAC Bipolar Cell showing no scale precipitation;

FIG. 9 is a graph of calcium ion concentration for product compartment inlet and outlet for a series of six runs at a current density of 0.369 mA/cm² along with the calculated percentage removal for a weak acid cation exchange cell with bipolar membrane (WAC Bipolar Cell);

FIG. 10 is a graph of conductivity versus throughput at a current density of 0.369 mA/cm² during a recharge mode of a WAC Bipolar Cell;

FIG. 11 shows voltage versus throughput for a series of recharge modes of a WAC Bipolar Cell at constant current density of 0.369 mA/cm²; and

FIG. 12 is a schematic drawing of an embodiment of an electrochemical cell that is referred to as a 5-cell pair, meaning there are 5 sets of cation permeable and bipolar membranes.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Provided are improved methods for recharging or regenerating electrochemical cells. In so providing, the methods substantially reduce potential for scale formation (calcium carbonate (CaCO₃), magnesium carbonate (MgCO₃), and the like) in the fluid streams adjacent to the electrodes. Specifically, electrochemical cells that utilize a bipolar membrane can use electrolyte streams in the concentrate compartment between the bipolar membrane and an electrode during regeneration to avoid the chance of ion precipitation and fouling of the membrane. A closed loop of an electrochemically inert electrolyte in solution, such as, sodium sulfate, is provided in the waste stream adjacent to, for example, the anode when a strong or weak acid cation resin is used in the product compartment and there is a cation-permeable membrane in the system. Likewise, it is contemplated that when a strong or weak basic cation is used in the product compartment and there is an anion-permeable membrane in the system, the closed loop of the electrolyte would be provided in the waste stream adjacent to the cathode. Because the sodium and sulfate ions, for example, are inert, the only electrochemical reactions in that stream produce hydrogen (H⁺) ions and oxygen (O₂) gas at the anode, while hydroxide ions (OH⁻) are produced at the bipolar membrane. The H⁻ and OH⁻ ions recombine to form water, and the O₂ gas is vented out of the stream. Since there is no calcium or other alkalinity present from an otherwise-supplied waste stream, there is no possibility of scale formation.

In addition, when strong acid cations are used in the product compartment, a portion of the acid water generated during the service mode can be routed to the catholyte compartment between the cation permeable membrane (CPM) and the cathode and be allowed to remain in the compartment for a time to dissolve any scale formed during a previous recharge mode. This can occur immediately after regeneration upon starting of the service mode, or at some other time interval during the service mode. Allowing the cathode and cation permeable membrane to soak for an extended time in low pH water will dissolve any residual scale and avoid fouling of the membrane.

Methods provided herein permit rechargeable electrochemical cells to be run maintenance free for long time periods by eliminating the possibility of scale formation.

By “electrochemically inert” it is meant that upon application of a current, an electrolyte stream that is electrochemically inert will retain its ions in solution, meaning that its ions do not exchange electrons with an electrode. Electrolyzers having half cell potentials that are high, for example 2 volts or greater, are desirable. Exemplary electrolytes are, for example, sodium sulfate (Na₂SO₄), sodium fluoride (NaF), potassium sulfate (K₂SO₄), and/or potassium fluoride (KF). An electrochemically inert electrolyte would include any ion pair that would undergo no reaction at the electrode, and therefore suitable electrolytes can be determined based on overall voltage and standard cell potential for a specific reaction/application

Reference to “ion exchange membrane” or “ion permeable membrane” means a membrane that selectively allows one type of ion to pass through while prevent other ions from passing through. Thus, a cation-permeable membrane allows cations, not anions, to cross, and, likewise, an anion-permeable membrane allows anions, not cations, to cross. A bipolar membrane is a structure that combines both a cation-permeable membrane and an anion-permeable membrane. Ion permeable membranes are known to those skilled in the art, and choice of such is based on environment of use and operating conditions. An exemplary cation-permeable membrane is sold under the trade name ResinTech CMB-SS, and an exemplary anion-permeable membrane is sold under the trade name ResinTech AMB-SS. An exemplary bipolar membrane is sold under the trade name NEOSEPTA BP-IE.

A “product compartment” is the part of the cell that holds resin for a desired treatment whose inlet receives incoming water to be treated and whose outlet provides treated water. A “concentrate compartment” is the part of the cell that receives and accumulates waste ions from the product compartment. The catholyte compartment is the part of the cell next to the cathode, and the anolyte compartment is the part of the cell next to the anode. The closed loop of an electrochemically inert electrolyte in solution will flow past one of the electrodes of the cell in an electrode compartment, that is, through either the anolyte or the catholyte compartment, depending on the cell design. Whichever electrode compartment is not used could also be considered a concentrate compartment, but generally will be referred to based on the electrode it is next to. In addition, for the use of multiple cell pairs, that is, pairs of desired membranes (e.g., a cation-permeable and bilpolar membrane used together or an anion-permeable membrane and a bipolar membrane used together), any compartments between the pairs that are not product compartments will be concentrate compartments for collecting waste ions.

By “current density” it is meant an amount of electrical current per unit area of cross section of the electrochemical cell. The choice of current density is one that is based on ensuring dissolved ions substantially remain in solution and do not precipitate out onto the ion exchange membranes for a given cell size/application. A desired current density can be chosen based on the expected duration of the recharge cycle. Low current densities can be used to provide the minimum amount of energy possible to ensure regeneration over a period time. A suitable current to achieve a desired current density can be determined upon set-up of an electrochemical cell, accounting for, for example, hardness, alkalinity, and TDS of the incoming water (e.g., tap water), flow rate of the waste stream. With respect to calcium carbonate as an indicator of potential for scaling, concentrations of calcium and carbonate in the waste stream are determined and the current density is adjusted to ensure the concentrations are below their solubility limits. For calcium, a calcium mass balance around the cell can be performed during a recharge mode. Calcium exiting a catholyte compartment is directly related to the current being applied. For carbonate, an equilibrium constant in view of the alkalinity and pH of the incoming water as well as the hydroxide produced at the cathode is used to estimate the carbonate concentration.

Electrochemical cells provided herein can further comprise a scale inhibition device, which is a device that discourages, directly or indirectly, adherence or deposition of ions on ion exchange membranes such as cation-permeable membranes or bipolar membranes. In one or more embodiments, the scale inhibition device comprises a control system for applying the low current density to the electrochemical cell, for pulsing the low current density to the electrochemical cell, or both. The pulsing can occur for a duration of time in the range of 1 milliseconds (mS) to 1 second (S), or even in the range of 10-100 mS. The pulsing can be applied at intervals of time of every 1 millisecond to 1 second, or even 10-500 mS.

Other scale inhibition devices can be one or more fluid conveyance layers. The surfaces of the one or more fluid conveyance layers can comprise non-smooth surface features such as channels. A “fluid conveyance layer” is a membrane or otherwise permeable structure effective to inhibit substantially accumulation of deposits thereon as well as on the ion exchange membranes. One or more embodiments provide that the surfaces of the fluid conveyance layers comprise non-smooth surface features. Such features improve fluid transfer by reducing the boundary layer. For example, the non-smooth surface features can comprise channels.

Reference to “service mode” of the electrochemical cell means the duration when incoming water to be purified enters the product compartment(s) of the cell and acid water leaves the product compartment(s). During the service mode according to embodiments provided herein, there is no current flowing to the cell.

Reference to “recharge mode” of the electrochemical cell means the duration when no water is being purified in the product compartment, a waste stream is supplied to the concentrate compartment(s), current is supplied to the cell, and the ion exchange resin is regenerated.

Before describing several exemplary embodiments of the invention, it is to be understood that the invention is not limited to the details of construction or process steps set forth in the following description. The invention is capable of other embodiments and of being practiced or being carried out in various ways.

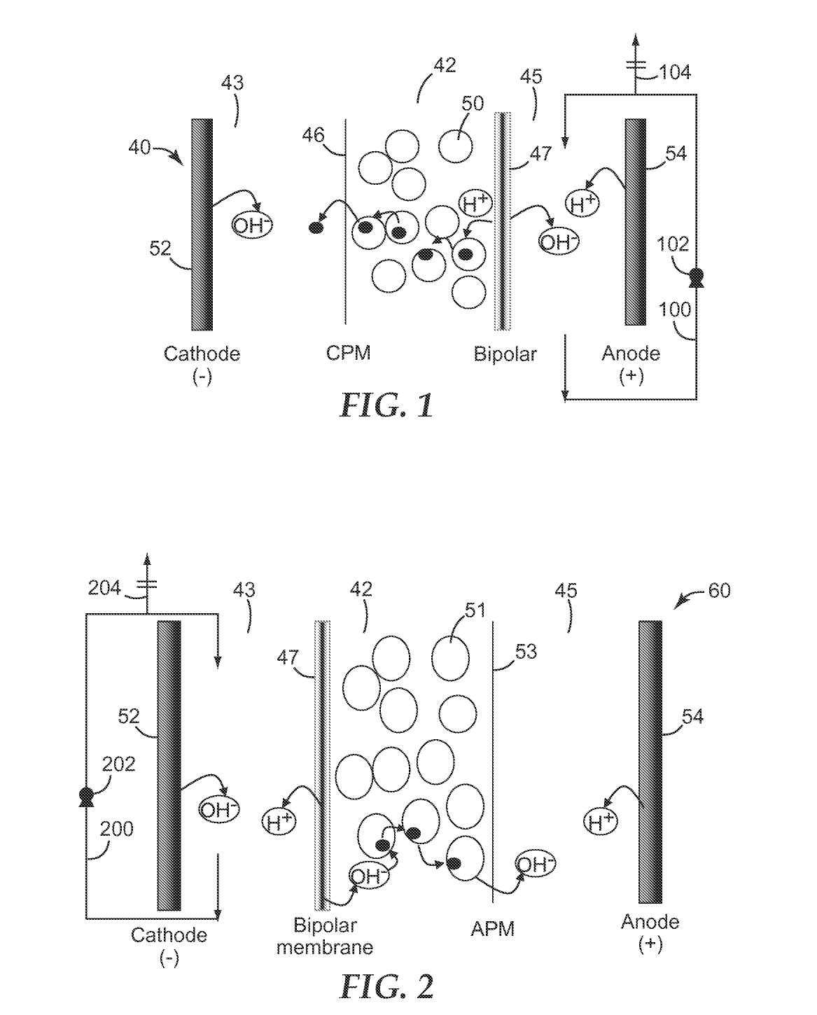

Turning to the figures, FIG. 1 shows an exemplary electrochemical cell 40 having a product compartment 42 containing a bed of strong cation resin in the hydrogen form 50 that is bound on one side by a cation-permeable membrane (CPM) 46, and on the other side by a bipolar membrane 47. An anolyte compartment 45 resides next to the anode 54, and a catholyte compartment 43 resides next to the cathode 52. During a recharge mode, an electrolyte stream 100 enters the anolyte compartment 45, which does not contain resin. During regeneration or the recharge mode, the electrolyte is electrochemically inert. Pump 102 is used as needed to keep the closed loop 100 circulating. Vent 104 is used to discharge any gas generated during the recharge mode. For example, when sodium sulfate is used in the closed loop 100, the only electrochemical reactions in that stream produce hydrogen (H⁺) ions and oxygen (O₂) gas at the anode, while hydroxide ions (OH⁻) are produced at the bipolar membrane. The H⁺ and OH⁻ ions recombine to form water, and the O₂ gas is vented through vent 104. Since there is no calcium or other alkalinity present from an otherwise-supplied waste stream, there is no possibility of scale formation. In operation of the recharge mode, upon application of a current density to the electrodes, the cations captured by the resin are replaced by H⁺ ions generated by electrolysis and by H⁺ ions generated by hydrolysis at the bipolar membrane and now migrate towards the cathode through the CPM. The EC waste stream receives the ions. Upon exiting the cell, the EC waste stream contains a higher amount of ions associated with alkalinity/TDS as compared to when it entered to cell. The cation resin is accordingly returned back to its acid form. Flow of the EC waste stream depends on the needs of the application, but generally the EC waste stream flow rate should be controlled in such a way as to maintain a low concentration of dissolved ions in the boundary layers adjacent to the selectively ion permeable membranes, keeping those concentrations below the concentrations at which dissolved salts might precipitate, while minimizing water use. The end of the recharge mode may be simply when demand for the acid water resumes or when the resins are substantially returned to their acid and base forms. The electrical regeneration eliminates a need for chemical regeneration with a strong acid. The electrochemical cell can be regenerated as needed and can be coordinated with the regeneration of the ion reduction device. The electrochemical cell can be used to depletion or to only partial depletion and regenerated during the recharge mode accordingly.

FIG. 2 shows an electrochemical cell 60 having a product compartment 42 containing a bed of strong or weak basic or anion resin 51 that is bound on one side by an anion-permeable membrane (APM) 53, and on the other side by a bipolar membrane 47. An anolyte compartment 45 resides next to the anode 54, and a catholyte compartment 43 resides next to the cathode 52. During a recharge mode, an electrolyte stream 200 enters the catholyte compartment 43, which does not contain resin. During regeneration or the recharge mode, the electrolyte is electrochemically inert. Pump 202 is used as needed to keep the closed loop 200 circulating. Vent 204 is used to discharge any gas generated during the recharge mode.

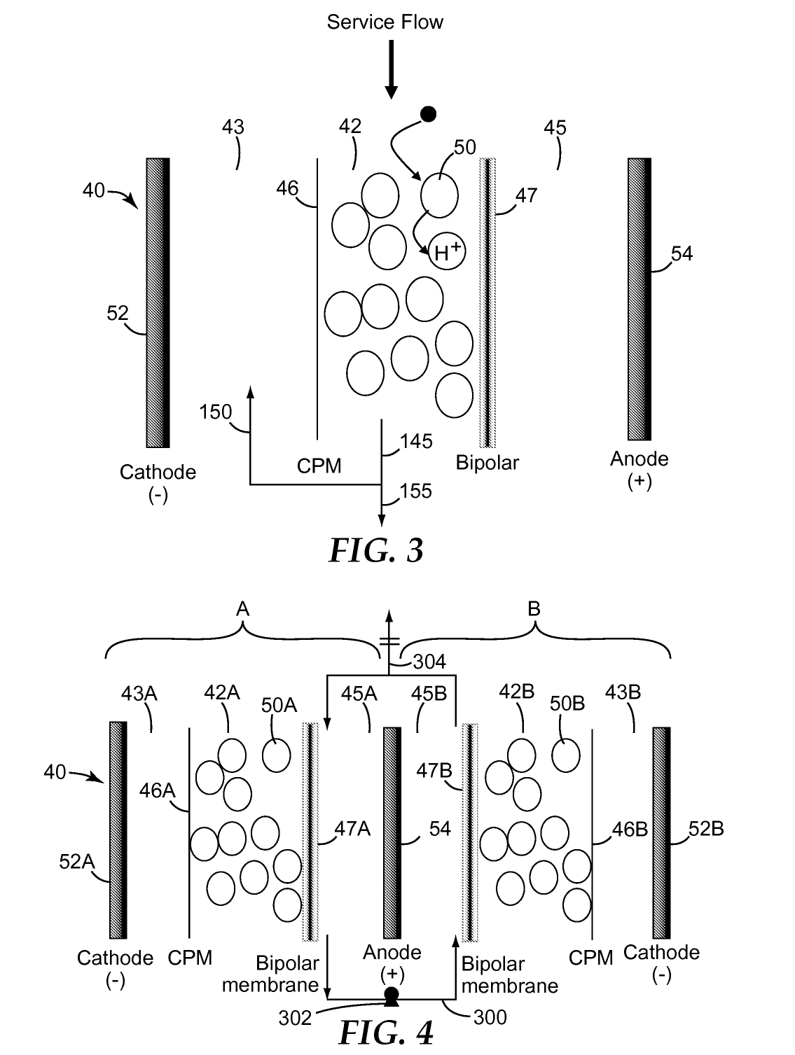

FIG. 3 depicts an electrochemical cell in accordance with one embodiment. Such a cell can be used with a single product compartment or with multiple product/concentrate compartments between the electrodes. In FIG. 3, service flow (incoming water such as tap water) is shown during a service mode when no current is applied to the electrochemical cell and depicting an electrochemical cell 40 that comprises, for example, a bed of strong cation resin in the hydrogen form 50 in a product compartment 42 that is bound on one side by a cation-permeable membrane (CPM) 46, and on the other side by a bipolar membrane 47. An anolyte compartment 45 that contains no resin is bound on one side by an anode 54 and on the other by the bipolar membrane 47. A catholyte compartment 43 that also contains no resin is bound on one side by a cathode 52 and on the other by the CPM 46. During the service mode, the water flows through the product compartment 42, where ions are removed by ion exchange. Specifically, cations bind to the cation exchange resin, displacing H⁻. Strong cation exchange resins are known in the art, with exemplary resins being those sold under the trade name DOWEX™ MARATHON™ C, which are resins having a styrene-divinylbenzene (DVB) gel matrix. During the service mode, substantially to completely all of the cations in passing through the cell are exchanged for hydrogen ions. So, the water exiting the cell at the other end of the product compartment (not shown) has an acidic pH, thereby forming acid water. Flow of the water depends on the needs of the application, but generally there should be sufficient contact time to achieve substantial exchange of cations by the ion exchange resin. Demand for the acid water for entry into the waste stream of the ion reduction device can be based on many factors, including, but not limited to volume treated through the ion reduction device, time, conductivity of the waste stream, rate of ions into the waste stream, parameters affecting LSI (Langelier Saturation Index) such as hardness, alkalinity, TDS, pH, and temperature, or any other indicator that ions of the ion concentrate compartment need to be flushed. It is noted that conductivity is a direct measure of total ion content in the waste stream. Product stream 145 can supply a downstream flow 155 or a slip stream 150. The slip stream 150 contains a portion of the acid water being produced during the service mode and is routed to the catholyte compartment 43 to dissolve any scale build-up.

The end of the service mode may be defined by the product water demand of the application, or by the time at which the resin is nearing exhaustion. Exhaustion of the resin can be determined, for example, by monitoring the conductivity of the outlet/acid water. Under the circumstances of producing acid water from a strong acid cation resin bed, conductivity decreases as the resin bed becomes exhausted as the hydrogen ion content decreases. In addition, exhaustion of the resin may be predicted based on volume of water treated based on, for example, information regarding the ion content of the income source (tap) water.

In FIG. 4, an embodiment having multiple compartments in parallel is shown. In this embodiment, one anode 54 is provided and sides A and B are provided so that one side at a time is operated while the other side is being regenerated or maintained. Operation can be conducted through one side of the electrochemical cell 40, e.g., side “A,” where the cell operates as discussed above using anode 54 and cathode 52A. The strong cation resin 50A in product compartment 42A is bound by a cation-permeable membrane (CPM) 46A and a bipolar membrane 47A. The first anolyte compartment 45A and the first catholyte compartment 43A contain no resin. Once maintenance and/or regeneration is needed on side “A” to, for example, recharge the resin and/or change out the resin and/or replace the cathode and/or replace either membrane, side “B” can be put into service using anode 54 and cathode 52B. The anode can be an expensive component, made from, for example, a noble metal, that can replaced less frequently than the other components of the cell and can be used for both sides in the embodiment of FIG. 4. With respect to side “B,” the strong cation resin 50B in product compartment 42B is bound by a cation-permeable membrane (CPM) 46B and a bipolar membrane 47B. The first anolyte compartment 45A and the first catholyte compartment 43A contain no resin. Both sides “A” and “B” can comprise further product and/or concentrate compartments (not shown).

During a recharge mode, an electrolyte stream 300 enters one or both of the anolyte compartments 45A or 45b, which does not contain resin. During regeneration or the recharge mode, the electrolyte is electrochemically inert. Pump 302 is used as needed to keep the closed loop 300 circulating. The closed loop can be valved and routed as needed through the anolyte compartments, either in series flow, as shown, or in parallel, depending on the application. Vent 304 is used to discharge any gas generated during the recharge mode.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used to describe the examples:
A: amp
cm: centimeter
C: Coulomb
gpg: grains per gallon
gpm: gallons per minute
in: inches
K: Conductivity
LSI: Langelier Saturation Index
μS: microsiemens
mA: milliamp
mg: milligram
cm²: square centimeter
ppm: parts per million
V: Volt

### Example 1

### Strong Acid Cation Bipolar Cell & Sodium Sulfate Loop

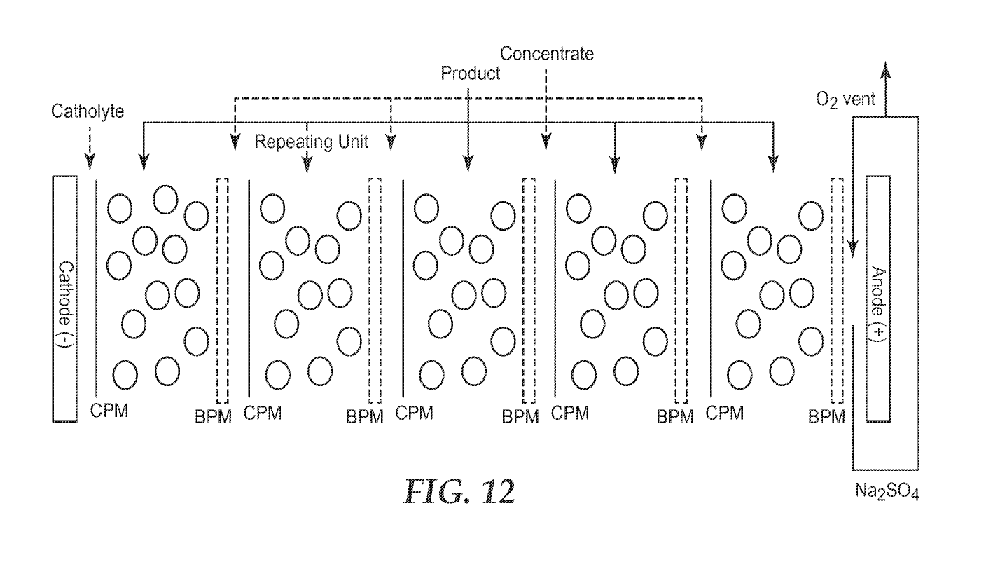

A 5-cell pair ion exchange cell with bipolar membrane was built. FIG. 12 is a schematic drawing of an embodiment of a 5-cell pair electrochemical cell, meaning there are 5 sets of cation-permeable and bipolar membranes. In this example, the ion was a strong acid cation (SAC) resin. Each of the five product compartments contained 125 grams of strong acid cation resin (SAC, 8% cross link, in H+ form) per cell pair, with Excellion Cation and bipolar membranes.

The performance of this strong acid cation exchange cell with bipolar membrane (SAC Bipolar Cell) was evaluated with Meriden, CT City water during 4 service and 3 recharge cycles.

Service mode/cycle: 1 or 3 gallons of Meriden city water was passed through the product compartment of the SAC Bipolar Cell at 0.25 gpm. The runs are shown in Table 1.

Recharge mode/cycle: After the desired amount of water was processed in one service mode, spent resin was regenerated under a constant current of 0.25 A. Target water was passed through the catholyte compartment at 0.05 gpm, and the supply to all of the concentrate compartments was 0.1 gpm. A closed loop sodium sulfate at 0.05 gpm was passed through the anolyte compartment to avoid scale formation on the anode.

Service Mode

During the service mode, production of acidified water was demonstrated. This acid water can be used to flush ions in a waste stream of an ion reduction device. Table 1 provides the water pH at the inlet of the product compartment (as present in the city water) and the outlet of the product compartment (after having pass through the SAC resin). The acidic water has a pH that is sufficient to reduce scale or prevent precipitation of salts in one or more ion concentration compartments.

TABLE 1

| | Run 1: | Run 2: | Run 3: | Run 4: |
|---|---|---|---|---|
| pH | 1 gallon | 3 gallons | 3 gallons | 3 gallons |
| Inlet | 7.2 | 7.5 | 7.6 | 7.4 |
| Outlet | 3.1 | 3 | 3.1 | 3.2 |

LSI was calculated based on the information in Table 2 to compare hard water with the low pH acidic water produced by the SAC Bipolar Cell.

TABLE 2

| | Hard water | |
|---|---|---|
| Water Quality | Comparative | Low pH |
| Hardness [ppm] | 300 | 300 |
| Alkalinity [ppm, CaCO₃] | 110 | 110 |
| TDS [ppm, CaCO₃] | 400 | 400 |
| pH | 8.3 | 3 |
| Temperature [° C.] | 20 | 20 |
| LSI | 0.78 | −4.52 |

Water at LSI<0 tends to be corrosive; at this low pH/low LSI, water will have the ability to remove scale by dissolving any calcium carbonate. This ability to dissolve calcium carbonate (CaCO₃) would not be expected from hard water having an LSI of, for example, 0.78.

Recharge Mode

During the recharge cycle, a voltage (at constant current density of 0.369 mA/cm²) was applied to the cell. The recharge cycle was terminated when conductivity in the waste concentrate stream (outlet conductivity), which was a collection of the water from each individual concentrate compartment, was close to inlet conductivity or remained unchanged with time.

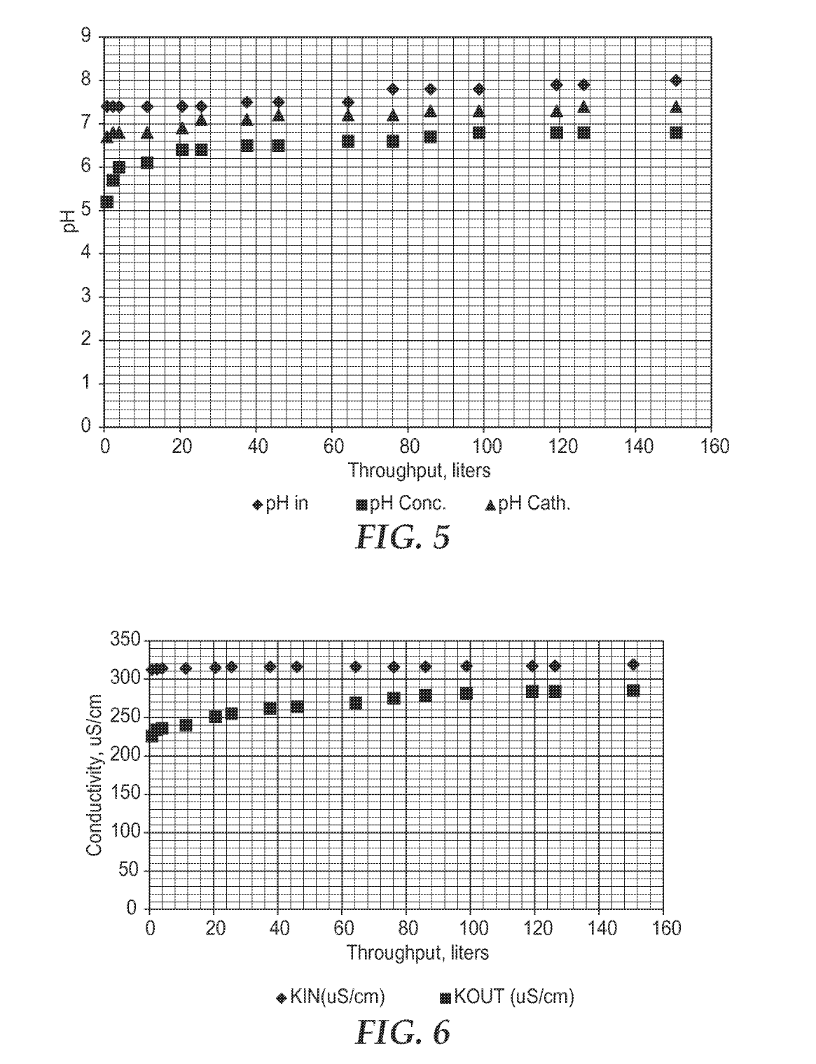

FIG. 5 is pH versus throughput during a representative recharge cycle, where “pH in” refers to the pH of the water incoming to the concentrate compartments, “pH Conc.” refers to the pH of the waste concentrate stream leaving the cell, and “pH Cath.” refers to the pH of the stream leaving the catholyte compartment. FIG. 6 shows conductivity versus throughput where KIN (μS/cm) refers to conductivity of incoming water and KOUT (μS/cm) refers to conductivity at the outlet of the concentrate compartments (collected into one waste concentrate stream).

Current Efficiency. Current efficiency is calculated based on total current passed during a recharge cycle (flow through concentrate compartments at 0.1 gpm, at constant current of 0.369 mA/cm²) and the current used for ion exchange obtained after recharge cycle. Table 3 shows that current efficiencies in the range of 4-6% were achieved.

TABLE 3

| Recharge Cycle | Service Mode | Current |
|---|---|---|
| Total charge (C) | (ppm of CaCO₃) | efficiency |
| 1: ~9900 | In: 120 | ~4% |
| | Out: <20 | |
| | Coulombs: 365 | |
| 2: ~5973 | In: 100 | ~5% |
| | Out: <20 | |
| | Coulombs: 292.23 | |
| 3: ~6153 | In: 120 | ~6% |
| | Out: 20 | |
| | Coulombs: 396.3 | |

### Example 2

### Sodium Sulfate Loop

The SAC Bipolar Cell according to Example 1 was used to demonstrate the concept of sodium sulfate loop through anolyte stream. Flow to each of the anolyte and catholyte compartments was independent, with flows being controlled separately.

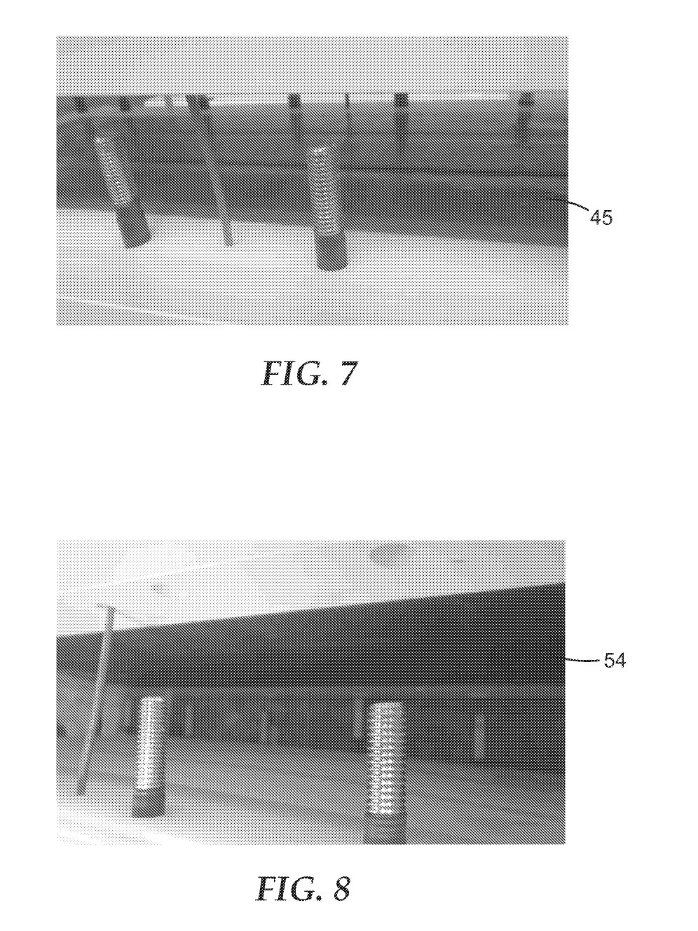

During a recharge mode and under the effect of a potential field, the possibility of scale precipitation in the anolyte compartment, which is located between the bipolar membrane and the anode electrode, is eliminated by the use of an electrochemically-inert, sodium sulfate (Na₂SO₄) loop. The SAC Bipolar Cell was opened for inspection after having been through the service and recharge cycles of Example 1, and it was confirmed there was no scale precipitation on either the bipolar membrane or the anode electrode. FIG. 7 is a photograph of the bipolar membrane 45 facing the anode showing no scale precipitation. FIG. 8 is a photograph of the anode 54 showing no scale precipitation. Thus, the use of an electrolyte of an electrochemically inert electrolyte in the anolyte compartment is an effective way to inhibit scale build-up during recharge.

### Example 3

### Weak Acid Cation Bipolar Cell & Sodium Sulfate Loop

The 5-cell pair ion exchange cell of Example 1 was then used with a weak acid cation (WAC) resin. Each of the five product compartments contained 125 grams of weak acid cation resin (Purofine, PFC104 plus), with Excellion Cation and bipolar membranes).

The performance of a this weak acid cation exchange cell (WAC Bipolar Cell) was evaluated with 10 gpg (grains per gallon of calcium carbonate hardness) water during 6 service and corresponding recharge cycles.

Service mode/cycle: 1 gallon of 10 gpg water was passed through the product compartment of the WAC Bipolar Cell at 0.25 gpm.

Recharge mode/cycle: After the desired amount of water was processed in one service mode, spent resin was regenerated. In this example, two different conditions were tested: (1) constant current density of 0.369 mA/cm² and (2) 0.147 mA/cm². Target water was passed through the catholyte compartment at 0.05 gpm, and the supply to all of the concentrate compartments was 0.1 gpm. A closed loop sodium sulfate at 0.05 gpm was passed through the anolyte compartment to avoid scale formation on the anode.

Service Mode

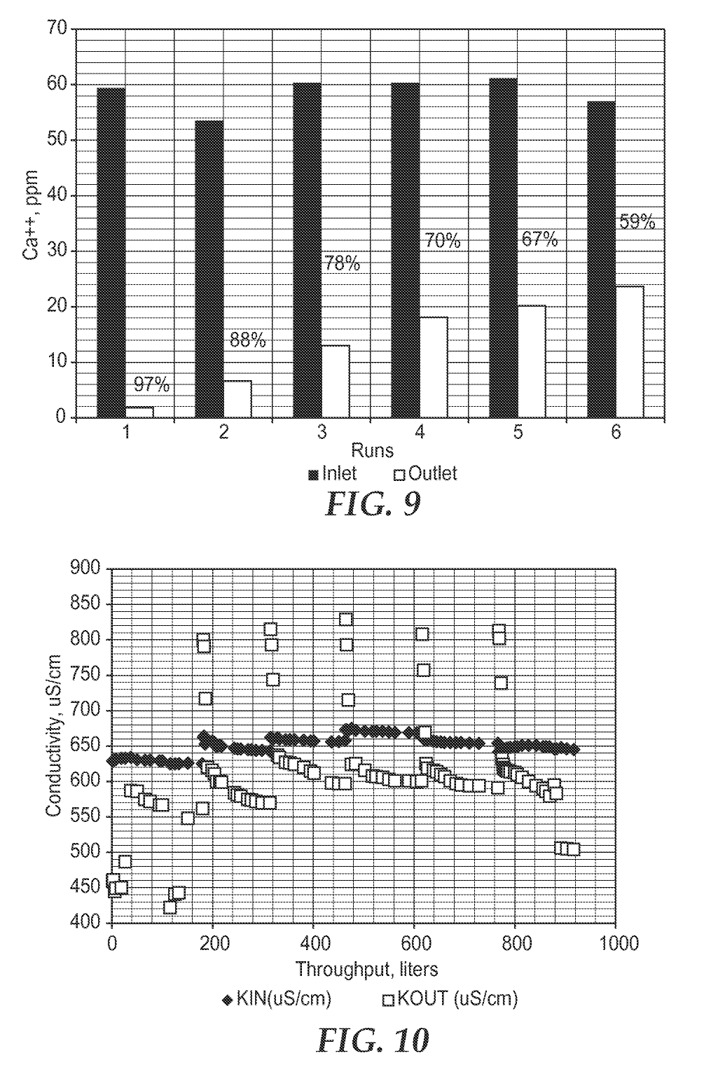

During the service mode, a decrease in calcium ion removal performance was noted from cycle to cycle. FIG. 9 shows the calculated percent calcium ion removed over a series of six runs, where calcium is measured in the water at the inlet and the outlet of the product compartment.

Recharge Mode at 0.369 mA/cm²

Current Density. Current density was calculated using a constant current of 0.25 A and a cell area of 18.25 in×5.75 in. The resulting current density was calculated by current/area was 0.369 mA/cm².

Ion Conductivity. The ion conductivity of inlet and outlet concentrate streams during the recharge cycle was measured. FIG. 10 shows conductivity versus throughput where KIN (μS/cm) refers to conductivity of incoming water and KOUT (μS/cm) refers to conductivity at the outlet of the concentrate compartments (collected into one waste concentrate stream). From this plot, it can be seen that cell is getting close to achieving a steady state behavior.

Ion Exchange and Current Efficiency. After recharge, the following ion exchange removal efficiencies were obtained:

Run 1 (brand new cell)=97% removal of hardness;

Run 2 (recharge cycle 1)=88% removal of hardness;

Run 3 (recharge cycle 2)=78% removal of hardness;

Run 4 (recharge cycle 3)=70% removal of hardness;

Run 5 (recharge cycle 4)=67% removal of hardness; and

Run 6 (recharge cycle 5)=59% removal of hardness.

Current efficiency is calculated based on total current passed during recharge cycle (flow through concentrate flow at 0.1 gpm, at constant current of 0.25 A) and the current used for ion exchange obtained after recharge cycle. Table 4 shows that current efficiencies in the range of 5-10% were achieved.

TABLE 4

| Recharge Cycle | Service Mode | Current |
|---|---|---|
| Total charge (C) | (ppm of CaCO₃) | efficiency |
| 1: ~6000 | In: 133 | 7% |
| | Out: 16.5 | |
| | Coulombs: 425.6 | |
| 2: ~4500 | In: 151 | 10% |
| | Out: 32.5 | |
| | Coulombs: 432.9 | |
| 3: ~6000 | In: 151 | 7% |
| | Out: 42.5 | |
| | Coulombs: 396.3 | |
| 4: ~6000 | In: 153 | 6% |
| | Out: 40.5 | |
| | Coulombs: 411 | |
| 5: ~6000 | In: 142 | 5% |
| | Out: 59 | |
| | Coulombs: 303.2 | |

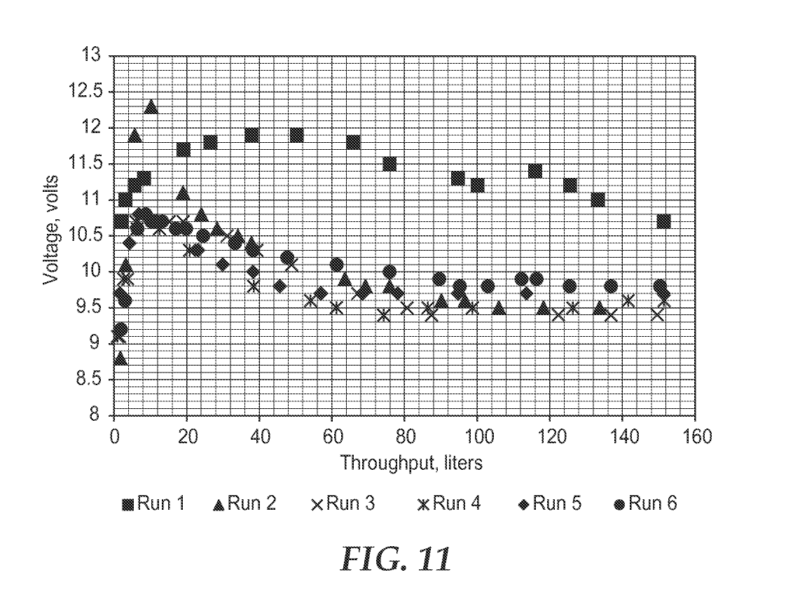

Voltage. There was no sign of precipitation on concentrate compartment from the measured voltage. Aside from run 1 (first run on a brand new cell), there was no a significant increase or change in voltage from run to run. FIG. 11 shows voltage versus throughput for a series of six runs during recharge mode at constant current density of 0.369 mA/cm².

Calcium Ion mass balance in concentrate compartment. Table 5 shows the calcium 2+ ion mass balance over a series of six runs, where calcium was measured in the incoming water and at the outlet of the concentrate compartments (collected into one waste concentrate stream).

TABLE 5

| | Ca²⁺ in, | Ca²⁺ out, | Ca²⁺ retained |
|---|---|---|---|
| Run | mg | mg | in conc., mg |
| 1 | 9191 | 5471 | 3720 |
| 2 | 6746 | 4124 | 2621 |
| 3 | 8716 | 6311 | 2405 |
| 4 | 9669 | 6419 | 3251 |
| 5 | 9427 | 6352 | 3076 |
| 6 | 8906 | 6402 | 2504 |
| 7 | — | — | — |

Despite the fact that the voltage measurement didn't suggest any sign of scale precipitation, the mass balance in concentrate stream shows that Ca2+ gets retained during the recharge process. In addition, at the beginning of recharge cycle 7, the maximum flow that could go through the concentrate compartments was about 0.05 gpm, indicating an increased pressure drop in concentrate stream caused by scale precipitation. Run 7 was not completed.

Several acid rinses were done on cell to remove any scale formed in concentrate stream, and lab data showed a significant amount of calcium and sodium ions in concentrate stream. Flow rate was been restored and cell was ready for testing under a different current density.

LSI was calculated for the concentrate compartments based on the information in Table 6 for the series of six runs.

TABLE 6

| Water Quality | Run 1 | Run 2 | Run 3 | Run 4 | Run 5 | Run 6 |
|---|---|---|---|---|---|---|
| Hardness | 148 | 148.5 | 144 | 159.6 | 155.6 | 147 |
| [ppm] | | | | | | |
| Alkalinity | 110 | 106 | 106 | 94 | 87 | 92 |
| [ppm, CaCO₃] | | | | | | |
| TDS | 333 | 384 | 409.4 | 378 | 382.4 | 382 |
| [ppm, CaCO₃] | | | | | | |
| pH | 8.3 | 8.1 | 8.2 | 7.86 | 8.08 | 8.12 |
| Temp | 20 | 20 | 20 | 20 | 20 | 20 |
| [° C.] | | | | | | |
| LSI | 0.48 | 0.26 | 0.34 | 0.00 | 0.17 | 0.21 |

For LSI>0, water is supersaturated with calcium carbonate, and scale precipitation may occur.

Recharge Mode at 0.147 mA/cm²

Service Mode. Once the WAC Bipolar Cell demonstrated above at 0.369 mA/cm² was recharged, another set of service and recharge modes were conducted. During the service mode for this additional series of runs, a 94% reduction in calcium carbonate was observed, very similar result obtained during first cycle of the 0.369 mA/cm² recharge mode example.

Current Density. Current density was calculated using a constant current of 0.1 A and a cell area of 18.25 in×5.75 in. The resulting current density was calculated by current/area was 0.147 mA/cm².

Ion Exchange and Current Efficiency. After recharge, the following ion exchange removal efficiencies were obtained:

Run 1 (after acid clean)=94% removal of hardness;

Run 2 (recharge cycle 1)=90% removal of hardness; and

Run 3 (recharge cycle 2)=93% removal of hardness.

Current efficiency is calculated based on total current passed during recharge cycle (flow through concentrate flow at 0.1 gpm, at constant current of 0.1 A) and the current used for ion exchange obtained after recharge cycle. Table 7 shows that a current efficiency in the range of 4-9% was achieved.

TABLE 7

| Recharge Cycle | Service Mode | Current |
|---|---|---|
| Total charge (C) | (ppm of CaCO₃) | efficiency |
| 1: ~9000 | In: 107 | 4% |
| | Out: 6 | |
| | Coulombs: 368.9 | |
| 2: ~6000 | In: 148 | 8% |
| | Out: 13 | |
| | Coulombs: 493 | |
| 3: ~6000 | In: 154 | 9% |
| | Out: 10.5 | |
| | Coulombs: 524 | |

Calcium Ion mass balance in concentrate compartment. Table 8 shows the calcium 2+ ion mass balance for one run, where calcium was measured in the incoming water and at the outlet of the concentrate compartments (collected into one waste concentrate stream).

TABLE 8

| | Ca²⁺ in, | Ca²⁺ out, | Ca²⁺ retained |
|---|---|---|---|
| Run | mg | mg | in conc., mg |
| 1 | 10115 | 8788 | 1327 |
| 2 | 9187 | 8382 | 805 |

A mass balance in concentrate stream shows that Ca2+ gets retained during the recharge process. However, upon recharging the cell at lower current density (0.147 mA/cm²), the amount retained in concentrate stream was significant lower (about 64% reduction) compared to running the cell at 0.369 mA/cm².

This supports the theory that precipitation during recharge can be inhibited or controlled and/or eliminated by running at low current densities while controlling concentrate flow rates to control the LSI.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

What is claimed is:

1. An electrochemical cell comprising:
a product compartment containing one or more ion-exchange resins;
a catholyte compartment and an anolyte compartment;
a bipolar membrane;
an ion-exchange membrane selected from the group consisting of a cation-permeable membrane and an anion-permeable membrane; and
a cathode and an anode; and
one or both of the following structures: a closed loop of an electrolyte stream in fluid communication with the bipolar membrane and either the anolyte compartment or the catholyte compartment and a slip stream that puts the ion-exchange membrane in fluid communication with the product compartment.

2. The electrochemical cell of claim 1 comprising the closed loop of the electrolyte stream, wherein the electrolyte comprises one or more ions that are electrochemically inert upon application of current to the cell.

3. The electrochemical cell of claim 1 comprising the closed loop of the electrolyte stream, wherein the electrolyte comprises sodium sulfate, sodium fluoride, potassium sulfate, potassium fluoride, or combinations thereof.

4. The electrochemical cell of claim 1 comprising the slip stream, wherein the one or more ion-exchange resins comprises a strong acid cation resin and the ion-exchange membrane comprises the cation-permeable membrane, wherein the slip stream delivers acid water from the product compartment to the catholyte compartment.

5. The electrochemical cell of claim 1, wherein the one or more ion-exchange resins comprises a cation exchange resin and the ion-exchange membrane comprises the cation-permeable membrane.

6. The electrochemical cell of claim 1, wherein the one or more ion-exchange resins comprises an anion exchange resin and the ion-exchange membrane comprises the anion-permeable membrane.

7. The electrochemical cell of claim 1 comprising two or more product compartments being separated by one or more concentrate compartments and containing one or more ion-exchange resins, each product compartment bounded by a pair of an ion-exchange membrane and a bipolar membrane.

8. The electrochemical cell of claim 1, having a service mode where no current density is applied to the electrochemical cell and a recharge mode where a current density is applied to the electrochemical cell.

9. The electrochemical cell of claim 8, wherein the current density is a low current density effective to substantially keep dissolved ions in solution in regions adjacent to the surfaces of the bipolar membrane and the at least one ion-exchange membrane during the recharge mode.

10. The electrochemical cell of claim 1 comprising two product or more compartments that contain a strong cation resin, an additional cathode adjacent to an additional catholyte compartment, an additional anolyte compartment that is adjacent to the anode, and the closed loop of the electrolyte stream, wherein the closed loop of the electrolyte stream flows through one or both of the anolyte compartments.

11. A method of treating water comprising: flowing water through the electrochemical cell of claim 1.

12. The method of claim 11, further comprising operating the electrochemical cell batch-wise having a service mode where no current density is applied to the electrochemical cell and a recharge mode where a current density is applied to the electrochemical cell.

13. The method of claim 12, wherein during the recharge mode, the electrochemically inert stream is supplied to one of the anolyte compartment and the catholyte compartment.

14. The method of claim 12, wherein during the service mode, acid water from the product compartment flows through the slip stream and into the catholyte compartment.

15. A method of treating water comprising: flowing water through the electrochemical cell of claim 10.
